(19) United States
(12) Patent Application Publication
(10) Pub. No.: US 2026/0220435 A1
(43) Pub. Date: Jul. 30, 2026

(54) MONITORING FRAMEWORKS FOR TWO-SIDED ARTIFICIAL INTELLIGENCE/MACHINE LEARNING MODELS

(71) Applicant: MEDIATEK INC., Hsinchu City (TW)

(72) Inventors: Pedram KHEIRKHAH SANGDEH, San Jose, CA (US); Gyu Bum KYUNG, San Jose, CA (US)

(21) Appl. No.: 19/149,195

(22) PCT Filed: Feb. 18, 2024
(86) PCT No.: PCT/CN2024/077430

§ 371 Date: Jul. 18, 2025

Related U.S. Application Data
(60) Provisional application No. 63/485,555, filed on Feb. 17, 2023.

(51) Int. Cl. G06N 3/0455; G06N 3/08; H04W 24/08

(52) U.S. Cl. CPC G06N 3/0455; G06N 3/08; H04W 24/08

(57) ABSTRACT

Techniques pertaining to monitoring frameworks for two-sided artificial intelligence and machine learning (AI/ML) models in wireless communications are described. An apparatus participates in training of a two-sided AI/ML model. The apparatus also performs a wireless communication by utilizing the two-sided AI/ML model. In participating in the training of the two-sided AI/ML model, the apparatus detects a change in a setting, scenario or environment and, in response to detecting the change, deactivates, switches or activates the two-sided AI/ML model or another two-sided AI/ML model.

### CROSS REFERENCE TO RELATED PATENT APPLICATION(S)

The present disclosure is part of a non-provisional application claiming the priority benefit of U.S. Patent Application No. 63/485,555, filed 17 Feb. 2023, the content of which herein being incorporated by reference in its entirety.

### TECHNICAL FIELD

The present disclosure is generally related to wireless communications and, more particularly, to monitoring frameworks for two-sided artificial intelligence and machine learning (AI/ML) models in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided AI/ML model, also known as autoencoders. As no model is a universal solution that fits all applications and/or all scenarios, monitoring is a function utilized in training a two-sided AI/ML model for a finite number of scenarios/settings. However, at the present time, there is not yet an effective monitoring framework for two-sided AI/ML models. Therefore, there is a need for a solution of monitoring frameworks for two-sided AI/ML models in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to monitoring frameworks for two-sided AI/ML models in wireless communications. It is believed that implementations of the various proposed schemes may address or otherwise alleviate the aforementioned issue(s). The various schemes proposed herein may be utilized in a variety of applications and scenarios such as, for example and without limitation, channel state information (CSI) compression, denoising (or noise reduction), quantization, coding, error correction codes, modulation, peak-to-average power ratio (PAPR) reduction, and image compression.

In one aspect, a method may involve an apparatus participating in training of a two-sided AI/ML model. The method may also involve the apparatus performing a wireless communication by utilizing the two-sided AI/ML model. In participating in training of the two-sided AI/ML model, the method may involve: (1) detecting a change in a setting, scenario or environment; and (2) deactivating, switching or activating the two-sided AI/ML model or another two-sided AI/ML model responsive to the detecting.

In yet another aspect, an apparatus may include a transceiver configured to communicate wirelessly and a processor coupled to the transceiver. The processor may participate in training of a two-sided AI/ML model. The processor may also perform a wireless communication by utilizing the two-sided AI/ML model. In participating in training of the two-sided AI/ML model, the processor may: (1) detect a change in a setting, scenario or environment; and (2) deactivate, switch or activate the two-sided AI/ML model or another two-sided AI/ML model responsive to the detecting.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a block diagram of an example communication system in accordance with an implementation of the present disclosure.

FIG. 10 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to monitoring frameworks for two-sided AI/ML models in wireless communications. According to the present disclosure, a number of possible solutions may be implemented separately or jointly. That is, although these possible solutions may be described below separately, two or more of these possible solutions may be implemented in one combination or another.

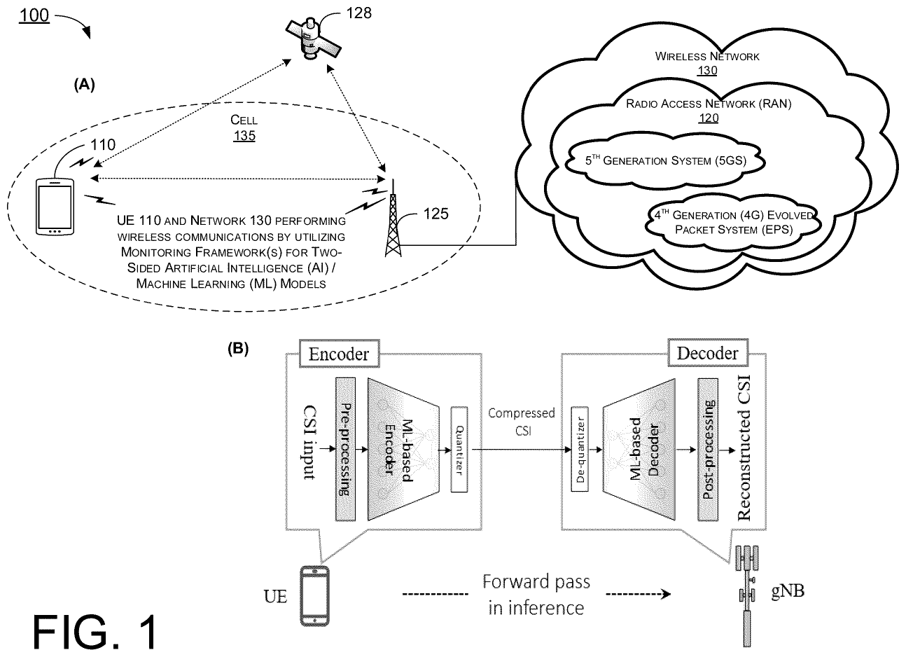

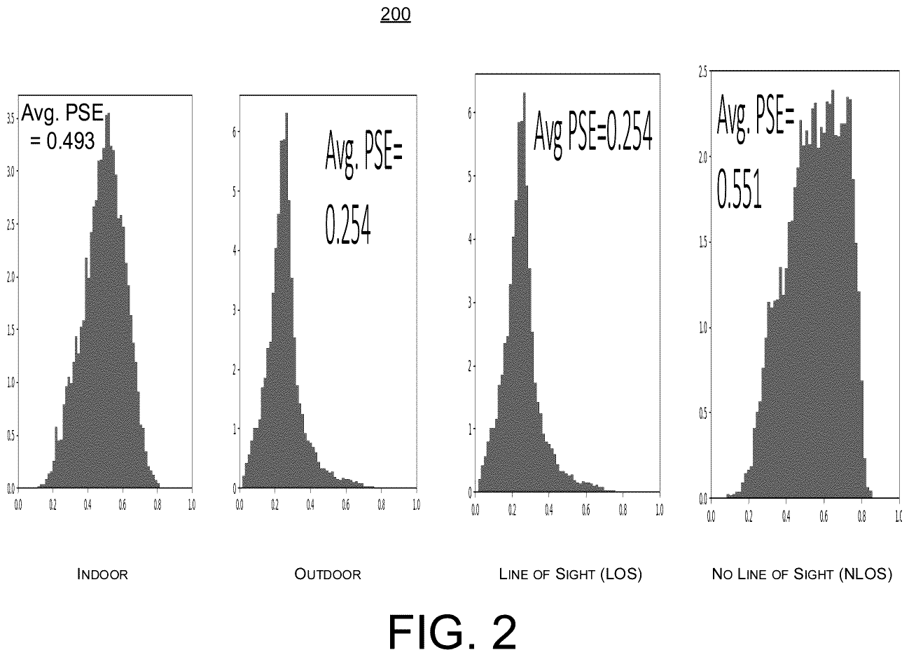

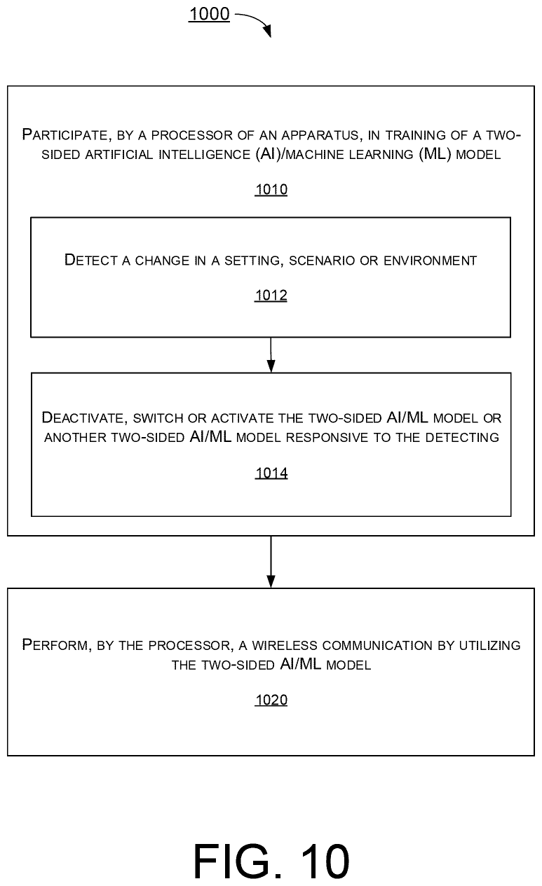

FIG. 1 illustrates an example network environment 100 in which various solutions and schemes in accordance with the present disclosure may be implemented. FIG. 2~FIG. 10 illustrate examples of implementation of various proposed schemes in network environment 100 in accordance with the present disclosure. The following description of various proposed schemes is provided with reference to FIG. 1~FIG. 10.

Referring to part (A) of FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to monitoring frameworks for two-sided AI/ML models in wireless communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Part (B) of FIG. 1 shows an example of a two-sided AI/ML model as a whole implemented at a UE, such as UE 110, and a network (NW), such as terrestrial network node 125 (e.g., a gNB) and/or non-terrestrial network node 128. The encoder and decoder of a two-sided AI/ML model may be specifically trained for a certain cell, area, configuration and/or scenario. Moreover, inference may be made in two entities, namely the UE and the network node. Based on the outcome of monitoring, the two-sided AI/ML model may be deactivated, switched, or activated when a new setting, scenario or environment is encountered. In the example shown in part (B) of FIG. 1, the two-sided AI/ML model is under training for the application of CSI compression, although other applications may be suitable as well (e.g., noise reduction, quantization, coding, error correction codes, modulation, PAPR reduction, and image compression).

Under a proposed scheme in accordance with the present disclosure, a monitoring framework for two-sided AI/ML models may involve an input or output (I/O)-based monitoring. Under the proposed scheme, any changes in the radio frequency (RF) environment, setting and/or scenario may be reflected in the input of the two-sided AI/ML model. Due to a unique mapping between the I/O of the two-sided AI/ML model, such changes may flow through the output as well. Thus, under the proposed scheme, changes may be tracked by inspecting statistics of the input and output (e.g., the statistics of I/O CSI at the UE/gNB for the application of CSI compression).

FIG. 2 illustrates an example scenario 200 under the proposed scheme. Referring to FIG. 2, an example of UE-side input-based model monitoring is shown, with power spectral entropy (PSE) as the monitored input. As shown in FIG. 2, the average PSE may differ in different environments, including indoor, outdoor, line-of-sight (LOS) and no LOS (NLOS) environments. As can be seen, the UE-side input-based model monitoring may effectively capture changes in the RF environment. 10

There are several advantages associated with the I/O-based monitoring. For instance, there is no need for disclosure of the AI/ML model of any side. There is no specific impact caused by monitoring, and there is no overhead of information exchange. Moreover, the I/O-based monitoring enables both network-side (or gNB-side) and UE-side monitoring. On the other hand, accuracy of the I/O-based monitoring may be lower compared to other types of monitoring, such as intermediate-key performance indicator (intermediate-KPI)-based monitoring described below.

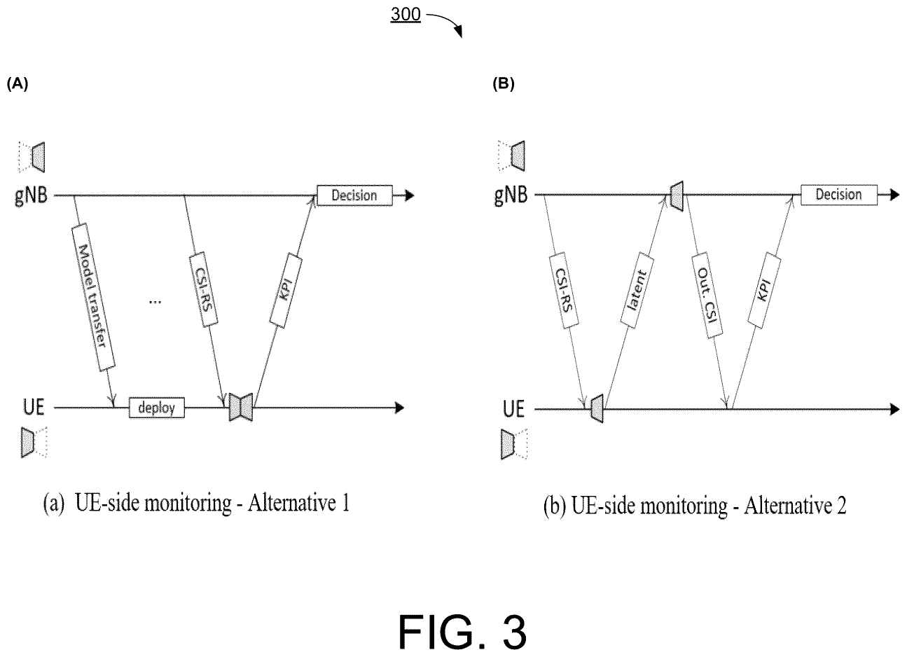

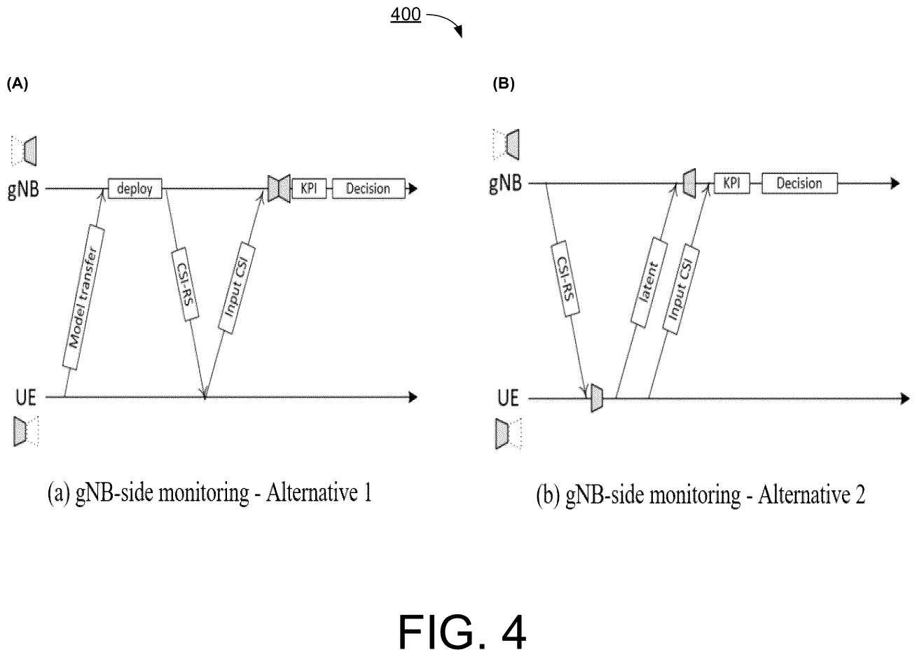

Under a proposed scheme in accordance with the present disclosure, a monitoring framework for two-sided AI/ML models may involve an intermediate-KPI-based monitoring. Under the proposed scheme, it may be sufficient to track intermediate KPIs in order to identify one or more shortcomings of a given two-sided AI/ML model. Moreover, the intermediate-KPI-based monitoring may involve a UE-side monitoring or a network-side monitoring, as described below with reference to FIG. 3 and FIG. 4.

FIG. 3 illustrates an example scenario 300 under the proposed scheme. Scenario 300 may pertain to an example of UE-side monitoring. Part (A) of FIG. 3 shows a first alternative (Alternative 1) of UE-side monitoring under the proposed scheme. Under Alternative 1, a network node of a network (e.g., a gNB of network 130) may send its decoder to a UE (e.g., UE 110) and, thereafter, the UE may access to the entire AI/ML autoencoder model and measure intermediate KPI(s) upon estimating input. However, this approach may require deployment efforts as well as disclosure of the AI/ML model by the network to the UE. Part (B) of FIG. 3 shows a second alternative (Alternative 2) of UE-side monitoring under the proposed scheme. Under Alternative 2, the network node (e.g., a gNB of network 130) may send the output of the model to the UE. The UE may measure intermediate KPI(s) as it has the access to both input and output samples. However, this approach may result in large overhead. It is noteworthy that, although the example shown pertains to a CSI compression application, the diagrams of FIG. 3 may be extended to any application with two-sided AI/ML models (e.g., noise reduction, quantization, coding, error correction codes, modulation, PAPR reduction, and image compression) by replacing channel state information reference signal (CSI-RS) with proper reference signals(s), output-CSI with output of the AI/ML model, and input CSI with input of the AI/ML model.

FIG. 4 illustrates an example scenario 400 under the proposed scheme. Scenario 400 may pertain to an example of network-side monitoring. Part (A) of FIG. 4 shows a first alternative (Alternative 1) of network-side monitoring under the proposed scheme. Under Alternative 1, a UE (e.g., UE 110) may send its encoder to a network node of a network (e.g., a gNB of network 130) and, thereafter, the network may measure intermediate KPI(s) upon receiving input and calculate output of the AI/ML model. However, this approach may require deployment efforts as well as disclosure of the AI/ML model by the UE to the network. Part (B) of FIG. 4 shows a second alternative (Alternative 2) of network-side monitoring under the proposed scheme. Under Alternative 2, the UE may send latent in conjugation with input of the AI/ML model to the network. Having access to the input, the network may measure intermediate KPI(s) upon calculating output of the AI/ML model. However, this approach may result in large overhead. It is noteworthy that, although the example shown pertains to a CSI compression application, the diagrams of FIG. 4 may be extended to any application with two-sided AI/ML models (e.g., noise reduction, quantization, coding, error correction codes, modulation, PAPR reduction, and image compression) by replacing CSI-RS with proper reference signals(s), output-CSI with output of the AI/ML model, and input CSI with input of the AI/ML model.

Under a proposed scheme in accordance with the present disclosure, a monitoring framework for two-sided AI/ML models may involve a UE/network-side proxy-based monitoring. Under the proposed scheme, one party (e.g., either the UE or the network node) may disclosure a proxy AI/ML model instead of its actual model, thereby maintaining the proprietary nature of its AI/ML model. A proxy AI/ML model may be used to form a proxy AI/ML autoencoder to result in or otherwise obtain or provide a drifted KPI which is drifted or otherwise shifted from an actual intermediate KPI. Any changes in the actual intermediate KPI may be reflected in the drifted KPI as well.

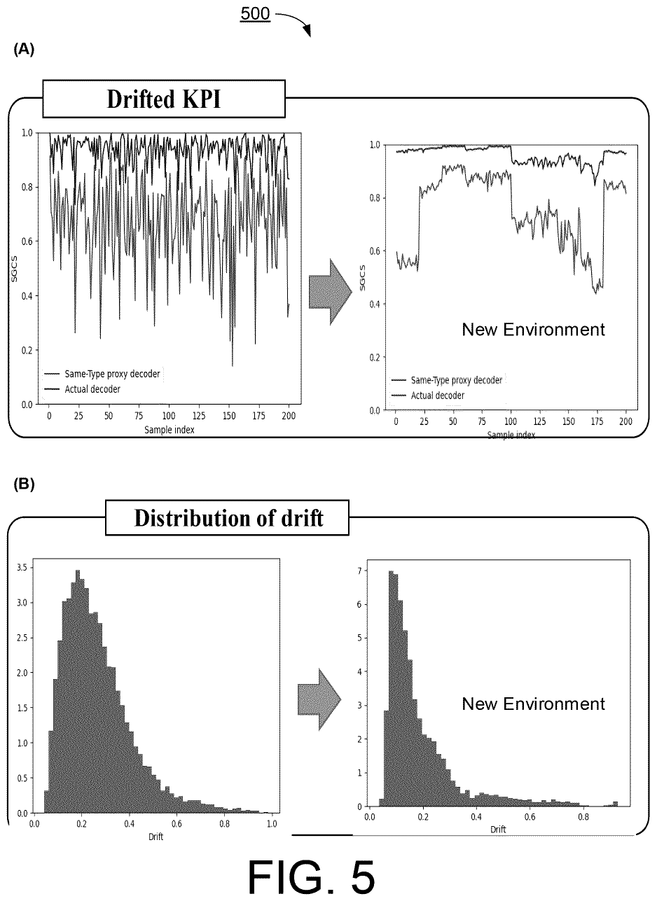

FIG. 5 illustrates an example scenario 500 under the proposed scheme. Part (A) of FIG. 5 shows an example of a drift between a drifted KPI relative to a corresponding actual intermediate KPI in an initial environment and in a new environment. Part (B) of FIG. 5 shows an example of a distribution of drift of the drifted KPI relative to the corresponding actual intermediate KPI in the initial environment and in the new environment.

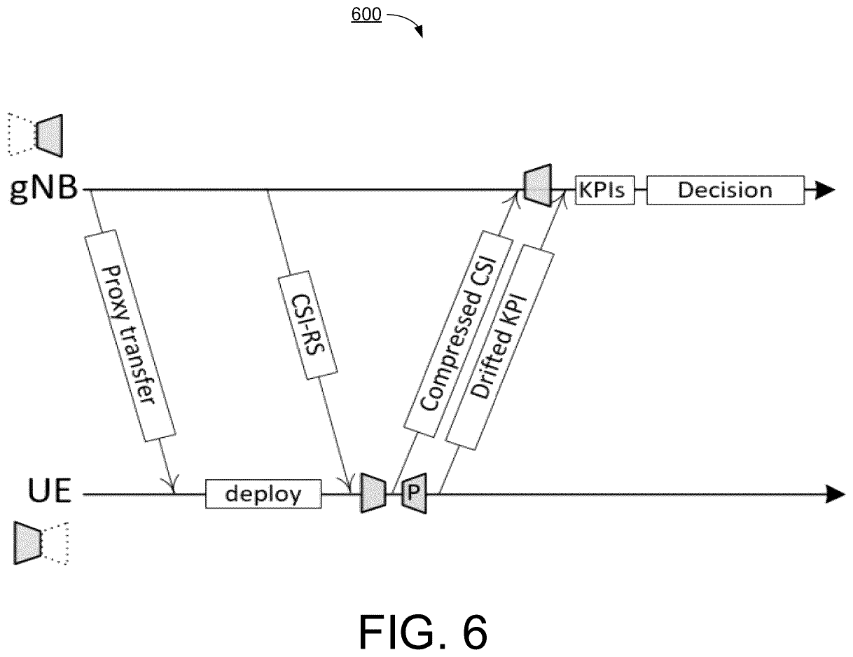

FIG. 6 illustrates an example scenario 600 of a UE-side proxy-based monitoring under the proposed scheme. Under the proposed scheme, UE-side proxy-based monitoring may involve a number of steps or stages. At a first step/stage, a network node of a network (e.g., a gNB of network 130) may send a proxy AI/ML model to a UE (e.g., UE 110) to enable the UE to form a proxy AI/ML autoencoder model. At a second step/stage, upon measuring the input, the UE may be able to obtain the drifted KPI. At a third step/stage, the UE may share the drifted KPI with the network in case that a monitoring event is detected (e.g., a change in the RF environment, such as a change in PSE, in which the UE is located). Advantageously, the overhead associated with the UE-side proxy-based monitoring may be relatively low, and there is no disclosure of the actual AI/ML model. It is noteworthy that, although the example shown pertains to a CSI compression application, the diagrams of FIG. 6 may be extended to any application with two-sided AI/ML models (e.g., noise reduction, quantization, coding, error correction codes, modulation, PAPR reduction, and image compression) by replacing CSI-RS with proper reference signals(s), output-CSI with output of the AI/ML model, and input CSI with input of the AI/ML model.

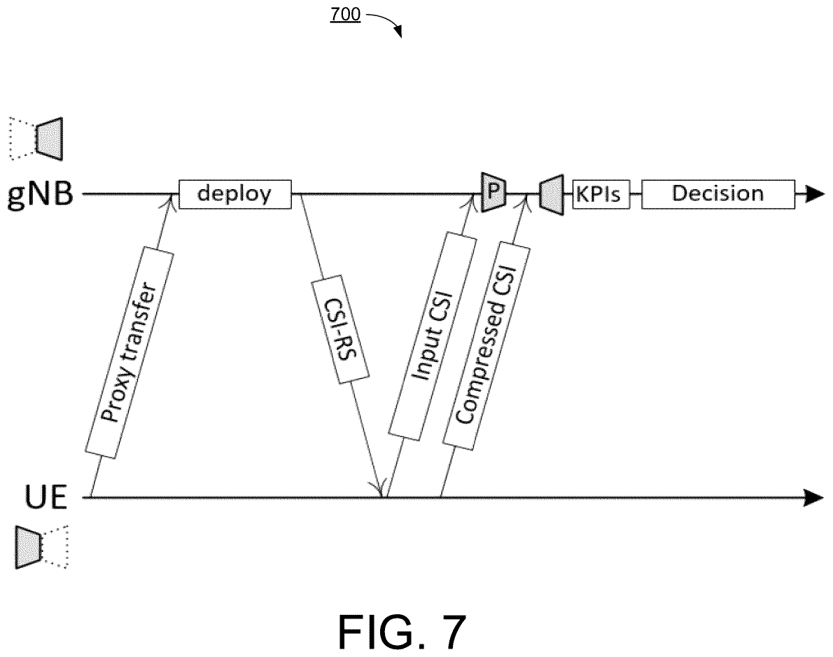

FIG. 7 illustrates an example scenario 700 of a network-side proxy-based monitoring under the proposed scheme. Under the proposed scheme, network-side proxy-based monitoring may involve a number of steps or stages. At a first step/stage, a UE (e.g., UE 110) may send a proxy AI/ML model to a network node of a network (e.g., a gNB of network 130) to enable the network to form a proxy AI/ML autoencoder model. At a second step/stage, the UE may send an input CSI for the sake of monitoring purposes. At a third step/stage, the network may calculate a drifted KPI for a possible monitoring action. Advantageously, there is no disclosure of the actual AI/ML model. However, the overhead associated with the network-side proxy-based monitoring may be relatively high. Consequently, the network-side proxy-based monitoring may be less appealing compared to the UE-side proxy-based monitoring. It is noteworthy that, although the example shown pertains to a CSI compression application, the diagrams of FIG. 7 may be extended to any application with two-sided AI/ML models (e.g., noise reduction, quantization, coding, error correction codes, modulation, PAPR reduction, and image compression) by replacing CSI-RS with proper reference signals(s), output-CSI with output of the AI/ML model, and input CSI with input of the AI/ML model.

Under a proposed scheme in accordance with the present disclosure, a monitoring framework for two-sided AI/ML models may involve a system-level monitoring. Under the proposed scheme, any change in the environment or configuration may be reflected in system-level/eventual KPIs. Examples of system-level KPIs may include, for example and without limitation, throughput, spectral efficiency, acknowledgement and negative acknowledgement (ACK/NACK) rates, and block error rate (BLER). The system-level monitoring may be less accurate as low performance may be attributed to either underperforming AI/ML model or harsh RF environment, setting or scenario.

Under a proposed scheme in accordance with the present disclosure, a monitoring framework for two-sided AI/ML models may involve a multi-stage monitoring. Notably, none of the above-described proposed schemes can individually offer an efficient monitoring tool in terms of overhead, accuracy and proprietariness. Under the proposed scheme, a low-overhead low-accuracy monitoring solution may trigger a more accurate intermediate-KPI-based monitoring solution with a higher overhead.

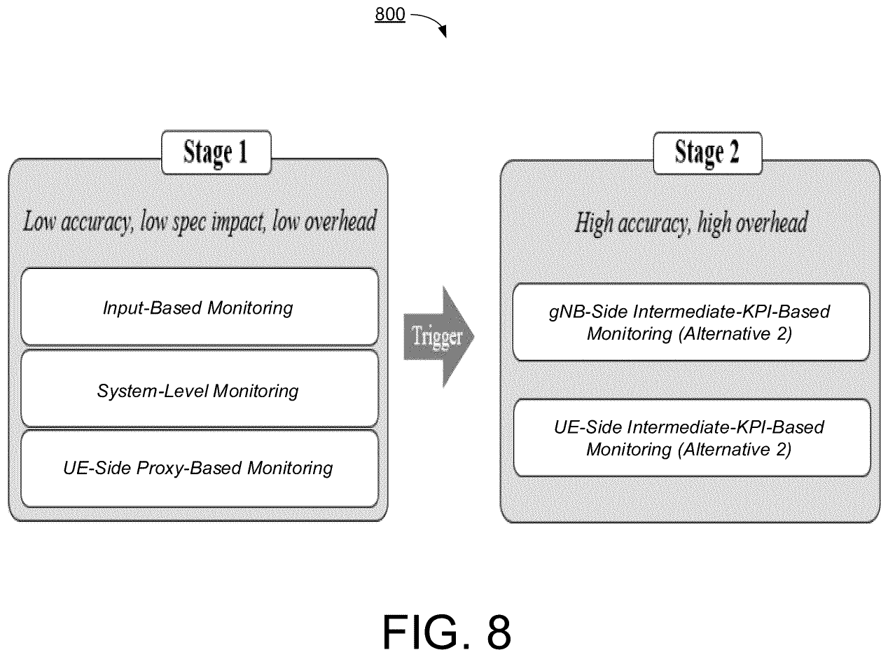

FIG. 8 illustrates an example scenario 800 under the proposed scheme. Referring to FIG. 8, at a first stage (Stage 1), a monitoring solution with low accuracy, low specific impact and low overhead may be utilized in the monitoring of a two-sided AI/ML model. For instance, one or more of the following monitoring solutions may be utilized: input-based monitoring, system-level monitoring, and UE-side proxy-based monitoring. Then, at a second stage (Stage 2), the low-overhead low-accuracy monitoring solution of Stage 1 may trigger another monitoring solution with higher accuracy yet with higher overhead. For instance, one or more of the input-based monitoring, system-level monitoring, and UE-side proxy-based monitoring, which is utilized at Stage 1, may trigger one or more of the following monitoring solutions at Stage 2: network-side intermediate-KPI-based monitoring under Alternative 2 (as shown in part (B) of FIG. 4) and UE-side intermediate-KPI-based monitoring under Alternative 2 (as shown in part (B) of FIG. 3). Advantageously, there is no need for disclosure of the AI/ML model. Moreover, low overhead and high accuracy may be achieved.

### Illustrative Implementations

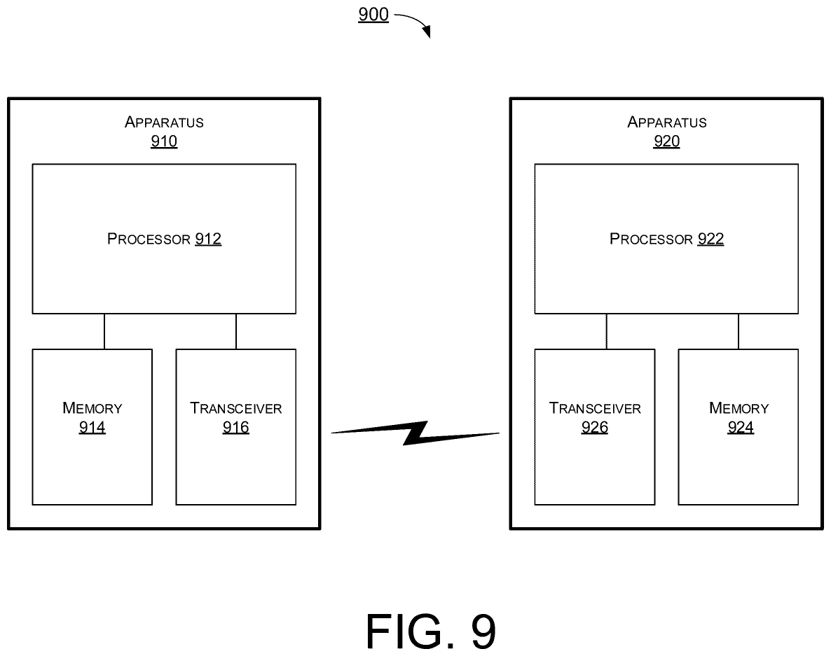

FIG. 9 illustrates an example communication system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 910 and apparatus 920 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 910 and apparatus 920 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in an eNodeB in an LTE, LTE-Advanced or LTE-Advanced Pro network or in a gNB or TRP in a 5G network, an NR network or an IoT network.

In some implementations, each of apparatus 910 and apparatus 920 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 910 and apparatus 920 may be implemented in or as a network apparatus or a UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC or RISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to monitoring frameworks for two-sided AI/ML models in wireless communications in accordance with various implementations of the present disclosure.

In some implementations, apparatus 910 may also include a transceiver 916 coupled to processor 912. Transceiver 916 may be capable of wirelessly transmitting and receiving data. In some implementations, transceiver 916 may be capable of wirelessly communicating with different types of wireless networks of different radio access technologies (RATs). In some implementations, transceiver 916 may be equipped with a plurality of antenna ports (not shown) such as, for example, four antenna ports. That is, transceiver 916 may be equipped with multiple transmit antennas and multiple receive antennas for multiple-input multiple-output (MIMO) wireless communications. In some implementations, apparatus 920 may also include a transceiver 926 coupled to processor 922. Transceiver 926 may include a transceiver capable of wirelessly transmitting and receiving data. In some implementations, transceiver 926 may be capable of wirelessly communicating with different types of UEs/wireless networks of different RATs. In some implementations, transceiver 926 may be equipped with a plurality of antenna ports (not shown) such as, for example, four antenna ports. That is, transceiver 926 may be equipped with multiple transmit antennas and multiple receive antennas for MIMO wireless communications.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a UE (e.g., UE 110), and apparatus 920, as a network node (e.g., network node 125) of a network (e.g., network 130 as a 5G/NR mobile network), is provided below in the context of example process 1000.

### Illustrative Processes

FIG. 10 illustrates an example process 1000 in accordance with an implementation of the present disclosure. Process 1000 may represent an aspect of implementing various proposed designs, concepts, schemes, systems and methods described above pertaining to monitoring frameworks for two-sided AI/ML models in wireless communications, whether partially or entirely, including those pertaining to those described above. Process 1000 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 1000 may be implemented by or in apparatus 910 and/or apparatus 920 as well as any variations thereof. Solely for illustrative purposes and without limiting the scope, each process is described below in the context of apparatus 910 as a UE (e.g., UE 110) and apparatus 920 as a communication entity such as a network node or base station (e.g., terrestrial network node 120) of a network (e.g., a 5G/NR mobile network). Process 1000 may begin at block 1010.

At 1010, process 1000 may involve processor 912 of apparatus 910 (e.g., as UE 110) participating in training of a two-sided AI/ML model (e.g., alone or together with apparatus 920 as terrestrial network node 125 or non-terrestrial network node 128). Process 1000 may proceed from 1010 to 1020.

At 1020, process 1000 may involve processor 912 performing, via transceiver 916, a wireless communication by utilizing the two-sided AI/ML model.

In some implementations, in participating in training of the two-sided AI/ML model, process 1000 may involve processor 912 performing certain operations as represented in 1012 and 1014.

At 1012, process 1000 may involve processor 912 detecting a change in a setting, scenario or environment. Process 1000 may proceed from 1012 to 1014.

At 1014, process 1000 may involve processor 912 deactivating, switching or activating the two-sided AI/ML model or another two-sided AI/ML model responsive to the detecting.

In some implementations, in participating in training of the two-sided AI/ML model, process 1000 may involve processor 912 performing I/O-based monitoring of the two-sided AI/ML model. In some implementations, in performing the I/O-based monitoring of the two-sided AI/ML model, process 1000 may involve processor 912 performing UE-side input-based model monitoring.

In some implementations, in participating in training of the two-sided AI/ML model, process 1000 may involve processor 912 performing intermediate-KPI-based monitoring of the two-sided AI/ML model. In some implementations, in performing the intermediate-KPI-based monitoring of the two-sided AI/ML model, process 1000 may involve processor 912 performing UE-side monitoring by tracking one or more intermediate KPIs on a UE side. Alternatively, in performing the intermediate-KPI-based monitoring of the two-sided AI/ML model, process 1000 may involve processor 912 performing network-side monitoring by tracking one or more intermediate KPIs on a network side.

In some implementations, in performing the UE-side monitoring, process 1000 may involve processor 912 performing certain operations. For instance, process 1000 may involve processor 912 receiving a decoder from a network node of a network (e.g., apparatus 920 as terrestrial network node 125 or non-terrestrial network node 128 of network 130). Additionally, process 1000 may involve processor 912 accessing the two-sided AI/ML model to measure the one or more intermediate KPIs upon estimating an input to the two-sided AI/ML model.

In some implementations, in performing the UE-side monitoring, process 1000 may involve processor 912 performing certain operations. For instance, process 1000 may involve processor 912 receiving an output of the two-sided AI/ML model from a network node of a network (e.g., apparatus 920 as terrestrial network node 125 or non-terrestrial network node 128 of network 130). Moreover, process 1000 may involve processor 912 accessing input and output samples of the two-sided AI/ML model to measure the one or more intermediate KPIs upon estimating an input to the two-sided AI/ML model.

In some implementations, in performing the network-side monitoring, process 1000 may involve processor 912 performing certain operations. For instance, process 1000 may involve processor 912 sending an encoder to a network node of a network (e.g., apparatus 920 as terrestrial network node 125 or non-terrestrial network node 128 of network 130). Moreover, process 1000 may involve processor 912 sending, to the network node, an input to the two-sided AI/ML model to enable the network to measure the one or more intermediate KPIs upon calculating an output of the two-sided AI/ML model.

In some implementations, in performing the network-side monitoring, process 1000 may involve processor 912 performing certain operations. For instance, process 1000 may involve processor 912 sending, to a network node of a network (e.g., apparatus 920 as terrestrial network node 125 or non-terrestrial network node 128 of network 130), a latent in conjugation with an input to the two-sided AI/ML model to enable the network to measure the one or more intermediate KPIs upon calculating an output of the two-sided AI/ML model.

In some implementations, in participating in training of the two-sided AI/ML model, process 1000 may involve processor 912 performing proxy-based monitoring of the two-sided AI/ML model. In some implementations, in performing the proxy-based monitoring of the two-sided AI/ML model, process 1000 may involve processor 912 forming a proxy AI/ML autoencoder that provides a drifted KPI which is drifted from an actual intermediate KPI and reflects a change in the actual intermediate KPI.

In some implementations, in performing the proxy-based monitoring of the two-sided AI/ML model, process 1000 may involve processor 912 performing UE-side proxy-based monitoring. In some implementations, in performing the UE-side proxy-based monitoring performing certain operations, process 1000 may involve processor 912 performing certain operations. For instance, process 1000 may involve processor 912 receiving a proxy two-sided AI/ML model from a network node of a network (e.g., apparatus 920 as terrestrial network node 125 or non-terrestrial network node 128 of network 130). Additionally, process 1000 may involve processor 912 forming a proxy AI/ML autoencoder model based on the proxy two-sided AI/ML model received from the network. Moreover, process 1000 may involve processor 912 measuring an input to the proxy AI/ML autoencoder model to obtain the drifted KPI. Furthermore, process 1000 may involve processor 912 sharing the drifted KPI with the network upon detecting a monitoring event.

In some implementations, in performing the proxy-based monitoring of the two-sided AI/ML model comprises performing network-side proxy-based monitoring. In some implementations, in performing the network-side proxy-based monitoring, process 1000 may involve processor 912 performing certain operations. For instance, process 1000 may involve processor 912 sending a proxy AI/ML model to a network node of a network (e.g., apparatus 920 as terrestrial network node 125 or non-terrestrial network node 128 of network 130) to enable the network to form a proxy AI/ML autoencoder model. Moreover, process 1000 may involve processor 912 sending, to the network node, an input to the proxy AI/ML model to enable the network to calculate the drifted KPI using the proxy AI/ML autoencoder model.

In some implementations, in participating in training of the two-sided AI/ML model, process 1000 may involve processor 912 performing system-level monitoring of the two-sided AI/ML model to detect the change in a setting, scenario or environment by monitoring one or more system-level KPIs. In some implementations, the one or more system-level KPIs may include at least one of a throughput, a spectral efficiency, ACK/NACK rates, and a block error rate (BLER).

In some implementations, in participating in training of the two-sided AI/ML model, process 1000 may involve processor 912 multi-stage monitoring of the two-sided AI/ML model by performing a first type of monitoring at a first stage and performing a second type of monitoring at a second stage. For instance, the first type of monitoring at the first stage may include one or more of the following: (i) input-based monitoring; (ii) system-level monitoring; and (iii) UE-side proxy-based monitoring. Moreover, the second type of monitoring at the first stage comprises one or more of the following: (i) network-side intermediate-(KPI-based monitoring; and (ii) UE-side intermediate-KPI-based monitoring.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and

C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
participating, by a processor of an apparatus, in training of a two-sided artificial intelligence (AI)/machine learning (ML) model; and
performing, by the processor, a wireless communication by utilizing the two-sided AI/ML model,
wherein the participating in training of the two-sided AI/ML model comprises:
detecting a change in a setting, scenario or environment; and
deactivating, switching or activating the two-sided AI/ML model or another two-sided AI/ML model responsive to the detecting.

2. The method of claim 1, wherein the participating in training of the two-sided AI/ML model comprises performing input or output (I/O)-based monitoring of the two-sided AI/ML model.

3. The method of claim 2, wherein the performing of the I/O-based monitoring of the two-sided AI/ML model comprises performing user equipment (UE)-side input-based model monitoring.

4. The method of claim 1, wherein the participating in training of the two-sided AI/ML model comprises performing intermediate-key performance indicator (KPI)-based monitoring of the two-sided AI/ML model.

5. The method of claim 4, wherein the performing of the intermediate-KPI-based monitoring of the two-sided AI/ML model comprises performing user equipment (UE)-side monitoring by tracking one or more intermediate KPIs on a UE side.

6. The method of claim 5, wherein the performing of the UE-side monitoring comprises:
receiving a decoder from a network node of a network; and
accessing the two-sided AI/ML model to measure the one or more intermediate KPIs upon estimating an input to the two-sided AI/ML model.

7. The method of claim 5, wherein the performing of the UE-side monitoring comprises:
receiving an output of the two-sided AI/ML model from a network node of a network; and
accessing input and output samples of the two-sided AI/ML model to measure the one or more intermediate KPIs upon estimating an input to the two-sided AI/ML model.

8. The method of claim 4, wherein the performing of the intermediate-KPI-based monitoring of the two-sided AI/ML model comprises performing network-side monitoring by tracking one or more intermediate KPIs on a network side.

9. The method of claim 8, wherein the performing of the network-side monitoring comprises:
sending an encoder to a network node of a network; and
sending, to the network node, an input to the two-sided AI/ML model to enable the network to measure the one or more intermediate KPIs upon calculating an output of the two-sided AI/ML model.

10. The method of claim 8, wherein the performing of the network-side monitoring comprises:
sending, to a network node of a network, a latent in conjugation with an input to the two-sided AI/ML model to enable the network to measure the one or more intermediate KPIs upon calculating an output of the two-sided AI/ML model.

11. The method of claim 1, wherein the participating in training of the two-sided AI/ML model comprises performing proxy-based monitoring of the two-sided AI/ML model.

12. The method of claim 11, wherein the performing of the proxy-based monitoring of the two-sided AI/ML model comprises forming a proxy AI/ML autoencoder that provides a drifted key performance indicator (KPI) which is drifted from an actual intermediate KPI and reflects a change in the actual intermediate KPI.

13. The method of claim 11, wherein the performing of the proxy-based monitoring of the two-sided AI/ML model comprises performing user equipment (UE)-side proxy-based monitoring.

14. The method of claim 13, wherein the performing of the UE-side proxy-based monitoring comprises:
receiving a proxy two-sided AI/ML model from a network node of a network;
forming a proxy AI/ML autoencoder model based on the proxy two-sided AI/ML model received from the network;
measuring an input to the proxy AI/ML autoencoder model to obtain the drifted KPI; and
sharing the drifted KPI with the network upon detecting a monitoring event.

15. The method of claim 11, wherein the performing of the proxy-based monitoring of the two-sided AI/ML model comprises performing network-side proxy-based monitoring.

16. The method of claim 15, wherein the performing of the network-side proxy-based monitoring comprises:
sending a proxy AI/ML model to a network node of a network to enable the network to form a proxy AI/ML autoencoder model; and
sending, to the network node, an input to the proxy AI/ML model to enable the network to calculate the drifted KPI using the proxy AI/ML autoencoder model.

17. The method of claim 1, wherein the participating in training of the two-sided AI/ML model comprises performing system-level monitoring of the two-sided AI/ML model to detect the change in a setting, scenario or environment by monitoring one or more system-level key performance indicators (KPIs), and wherein the one or more system-level KPIs comprise at least one of a throughput, a spectral efficiency, acknowledgement and negative acknowledgement (ACK/NACK) rates, and a block error rate (BLER).

18. The method of claim 1, wherein the participating in training of the two-sided AI/ML model comprises performing multi-stage monitoring of the two-sided AI/ML model by performing a first type of monitoring at a first stage and performing a second type of monitoring at a second stage.

19. The method of claim 18, wherein:
the first type of monitoring at the first stage comprises one or more of:
input-based monitoring;
system-level monitoring; and
user-equipment (UE)-side proxy-based monitoring, and
the second type of monitoring at the first stage comprises one or more of:
network-side intermediate-key performance indicator (KPI)-based monitoring; and
UE-side intermediate-KPI-based monitoring.

20. An apparatus, comprising:
a transceiver configured to communicate wirelessly; and
a processor coupled to the transceiver and configured to perform operations comprising:
participating in training of a two-sided artificial intelligence (AI)/machine learning (ML) model; and
performing, via the transceiver, a wireless communication by utilizing the two-sided AI/ML model,
wherein the participating in training of the two-sided AI/ML model comprises:
detecting a change in a setting, scenario or environment; and
deactivating, switching or activating the two-sided AI/ML model or another two-sided AI/ML model responsive to the detecting.
